(19) United States
(12) Patent Application Publication
(10) Pub. No.: US 2025/0336624 A1
(43) Pub. Date: Oct. 30, 2025

(54) KEYBOARD AND KEY STEM CONFIGURED FOR REMOVABLY HOLDING A KEYCAP

(71) Applicant: Norbauer & Co. LLC., Los Angeles, CA (US)

(72) Inventors: Ryan Norbauer, Los Angeles, CA (US); Bo Noergaard Klerk, Copenhagen (DK)

(21) Appl. No.: 18/647,263

(22) Filed: Apr. 26, 2024

(51) Int. Cl. H01H 13/70; H01H 13/14; H01H 13/20

(52) U.S. Cl. CPC H01H 13/70; H01H 13/14; H01H 13/20

(57) ABSTRACT

Presently provided is a keyboard with at least one of the keys having a key stem configured and disposed to interface with, and removably hold, a keycap. The key stem extends upwardly from a keyboard switch or a keycap stabilizer and has two or more extensions extending outwardly from a common center. At least one flexible or springing member extends from or forms at least one of the extensions and applies retentive forces on interior surfaces of a keycap stem extending downwardly from a keycap's interior ceiling and removably holds the keycap with the key stem.

### FIELD OF INVENTION

The present invention relates to keyboards having key stems for holding keycaps with keyboards.

### BACKGROUND OF THE INVENTION

A common keyboard keycap type currently in use, such as alphanumeric character keys, may have a single cruciform keycap stem in their centers. Longer keys such as a spacebar may have one or two additional cruciform keycap stems positioned to be placed to the side(s) of a keyboard switch position. The longer keys may have a stabilizer mechanism configured to stabilize the keycap upon being pressed. These key stems fit into mating cruciform key stems on keyboard switches or on stabilizer mechanisms positioned on either side of the keyboard switch.

A common method of interfacing or holding a keycap to a keyboard switch or stabilizer mechanism is to have a cruciform stem on the keyboard switch's mounting point or stabilizer mounting points. These stems are effectively positively extruded “+” sign configurations. On the keycap there is typically a corresponding negatively cut geometry within a cylindrical keycap stem that extends down from the keycap's interior ceiling. For example, the Cherry IM MX style keycap has a keycap stem with a negative cruciform geometry. These keycaps are typically made of ABS or PBT thermoplastics and are press-fit onto spring-loaded electrical keyboard switches of various types.

These interfaces will typically use interference fits and/or crush ribs to retain the keycap in place during key keyboard switch use. The removal and installation of these typical interference fit keycaps may be difficult. Additionally, removal and replacement of these keycaps may wear or microscopically remove material on the keycap stem interior walls and the retentive force of the fit may tend to diminish on multiple removals and subsequent re-installations of keycaps onto the key stems. Addition of material to the key stem to allow for tighter and more durable fits risks cracking the keycap stem. These keycap mounting approaches of the prior art may thus have deficiencies.

To mitigate some of the deficiencies of the prior art, it may be desirable to improve upon the current keycap interfaces or key stems.

### SUMMARY

In one aspect of the present disclosure, a keyboard is provided. The keyboard comprises a plurality of keys, each having a keycap supported with a switch, which is in turn supported with a keyboard switch plate or a PCB. Each of the keys are in communication with a keyboard switch configured and disposed to bias the keycaps from the keyboard switch plate or PCB. At least one of the keys has a key stem configured and disposed to interface with, and removably hold, one of the keycaps. The key stem extends upwardly from the keyboard switch or a keycap stabilizer and has two or more extensions extending outwardly from a common center. At least one flexible or springing member extends from at least one of the extensions. The at least one flexible or springing member is configured and disposed to apply retentive forces on interior surfaces of a keycap stem extending downwardly from the keycap's interior ceiling and to removably hold the keycap with the key stem.

In another aspect of the present disclosure, a key stem configured and disposed to interface with, and removably hold, a keycap is provided. The key stem extends upwardly from a keyboard switch or a keycap stabilizer and has two or more extensions extending outwardly from a common center. At least one flexible or springing member extends from at least one of the extensions. The at least one flexible or springing member is configured and disposed to apply retentive forces on interior surfaces of a keycap stem extending downwardly from the keycap's interior ceiling and to removably hold the keycap with the key stem.

### BRIEF DESCRIPTION OF THE DRAWINGS

The foregoing and other features of this disclosure will become more fully apparent from the following description and appended claims, taken in conjunction with the accompanying drawings and examples. Understanding that these drawings depict only several embodiments in accordance with the disclosure and are therefore, not to be considered limiting of its scope, the disclosure will be described with additional specificity and detail through use of the accompanying drawings.

The following figures, which are idealized, are not to scale and are intended to be merely illustrative of aspects of the present disclosure and non-limiting. In the drawings, like elements may be depicted by like reference numerals. The drawings are briefly described as follows:

FIGS. 1A, 1B, and 1C show an illustrative example of prior art keyboards, keycaps, and key stems;

FIG. 2 shows an illustrative example of a keycap holder having a key stem of the present disclosure;

FIG. 3 shows an illustrative example of a keycap holder of the present disclosure installed with a keycap stabilizer and a keyboard switch;

FIGS. 4A and 4B shows an illustrative embodiment of a key stem of the present disclosure; and

FIG. 5 shows illustrative examples of a key stem of the present disclosure and associated forces for removably holding a keycap.

### DETAILED DESCRIPTION OF THE INVENTION

The presently disclosed key stem configured for removably holding a keycap with a keyboard switch or a keycap stabilizer mounting points may overcome some of the deficiencies of prior key holder or key stem designs. The presently disclosed key stem has at least one flexible or springing member that interfaces with an interior surface of a keycap stem. The presently disclosed key stem may not result in the same degree of plastic deformation or keycap material erosion as prior art designs. For example, the presently disclosed key stem may maintain retentive forces with a keycap over an extended period of time and may cause less damage to the keycaps. Such an advantage may be exemplified with removal and replacement of keycaps from the key stems. Additionally, the retentive forces of the keycap on the key holder or key stem may be more closely controlled and maintained.

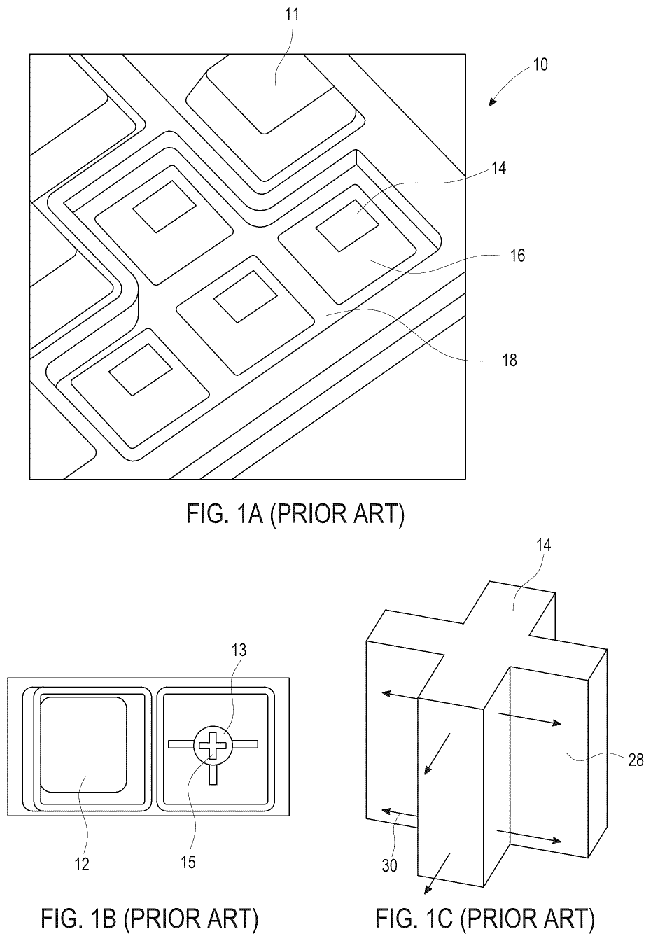

FIG. 1A shows an illustrative example of prior art keyboard 10. Keyboard 10 has a plurality of keys 11, each having a keycap 12. Keyboard switch 16 is a mechanism that is disposed beneath each keycap 12 on keyboard 10. Keyboard switch 16 is configured for registering when a keycap 12 is pressed. There are several types of keyboard switches available, including mechanical, capacitive, rubber membrane, and scissor keyboard switches. Keyboard switch 16 may include a keycap lifting mechanism configured and disposed to bias the keycaps 12 from keyboard switch plate or PCB 18.

FIG. 1B shows keycaps 12 each having at least one keycap stem 13 extending downwardly from its interior ceiling. Keycap stem 13 is configured to hold keycap 12 with the key stem 14. FIG. 1C shows key stem 14 configured and disposed to interface with, and hold, keycap 12. Key stem 14 has a positively extruded cruciform (“+” sign) configuration. Key stem 14 is disposed to extend upwardly from keyboard switch 16 and has four perpendicularly disposed key stem extensions 28 extending outwardly from a common center. Keycap stem 13 has a corresponding negatively cut geometry within a cylindrical extension extending down from an interior ceiling of keycap 12, disposing interior surface 15.

Force vectors 30 illustrate the retentive forces between key stem 14 and keycap stem 13, upon inserting keycap stem 13 in key stem 14. In the prior art, force vectors 30 may extend the perimeter of key stem 14, including all four key stem extensions 28. Force vectors 30 may, or may not, have a similar magnitude around the perimeter of key stem 14. Force vectors 30 may vary around the perimeter of key stem 14 depending upon the tolerances or variations of key stem 14 and keycap stem 13.

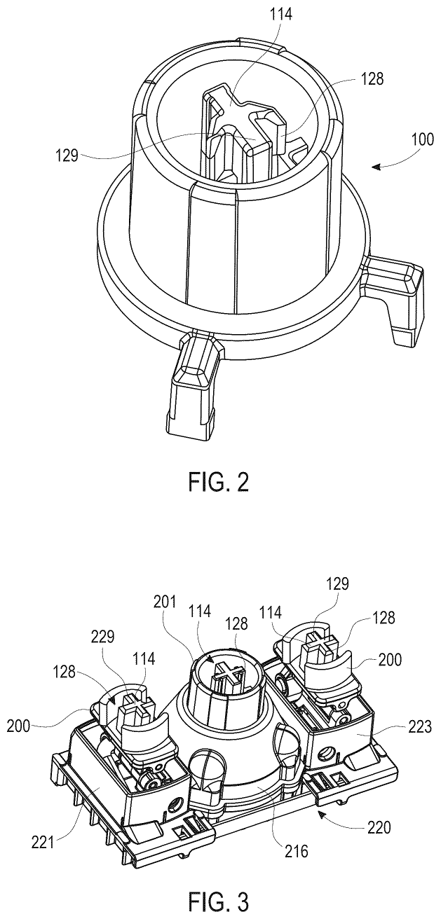

FIG. 2 shows keycap holder 100 having key stem 114 of the present disclosure. In at least one embodiment of the present disclosure, keycap holder 100 is configured to removably hold keycap 12 and keycap stem 13. For example, key stem 114 may be configured to be inserted into the negatively cruciform cut geometry of interior surface 15 of keycap stem 13.

Key stem 114 is configured and disposed to interface with, and removably hold, a keycap, such as keycap 12. Key stem 114 is configured to extend upwardly from a keyboard switch or a keycap stabilizer and has two or more extensions 129 extending outwardly from a common center. At least one flexible or springing member 128 forms or extends from at least one of the extensions 129. Flexible or springing member 128 is configured and disposed to apply retentive forces on interior surfaces, such as interior surfaces 15, of keycap stem 13 extending downwardly from keycap's 12 interior ceiling. The retentive forces are of a magnitude to removably hold a keycap 12 and key stem 114. For example, one or more extensions 129 may have or form a flexible or springing member 128 in the form of a flexible tip of an extension 129.

FIG. 3 shows an illustrative example of keycap holders 200 and 201 of the present disclosure installed with a keycap stabilizer 220 and a keyboard switch 216, respectively. Keycap holders 200 and 201 each have a key stem 114 of the present disclosure. In at least one embodiment of the present disclosure, two key holders 200 and centrally disposed key holder 201 are configured to removably hold a longitudinally extending key, such as a spacebar. For example, three key stems 114 may be configured to be inserted into the negatively cut cruciform geometry of interior surfaces 15 of three keycap stems 13 extending from the longitudinally extending key.

Keycap holder 201 may be configured to attach to a keyboard switch 216. Key holders 200 may be configured to be movably supported about housings 221 and 223 of keycap stabilizer 220. Keycap stabilizer housings 221 and 223 and keyboard switch 216 may be held with keyboard switch plate or PCB 18.

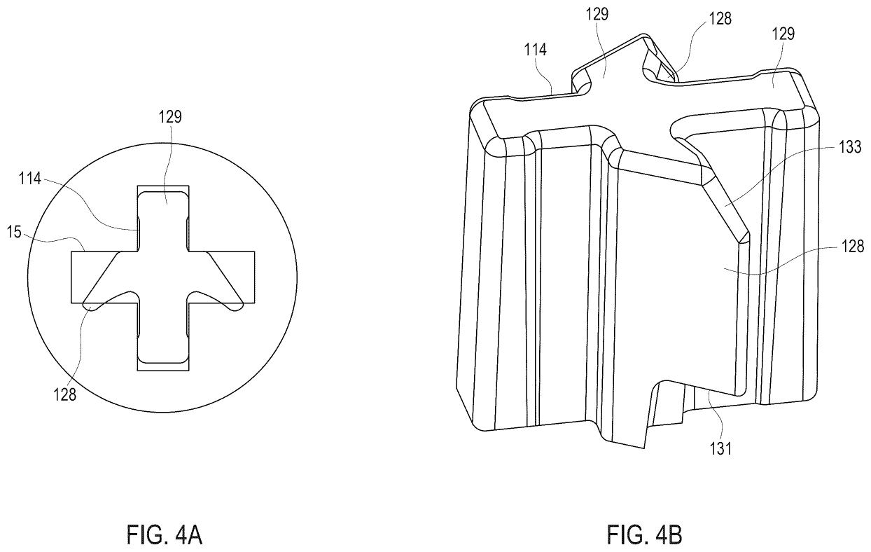

FIGS. 4A and 4B show a top and perspective view of key stem 114 configured to removably hold a keycap 12. Key stem 114 is configured and disposed to interface with, and removably hold, a key 11 having a keycap 12. Key stem 114 is configured to extend upwardly from a keyboard switch or a keycap stabilizer and has two or more extensions 129 extending outwardly from a common center. Key stem 114 has at least one flexible or springing member 128 extending from at least one of extensions 129. For example, key stem 114 may have flexible or springing members 128 extending from or forming oppositely disposed extensions 129 in a wing-like configuration.

FIG. 4A shows extensions 129 and flexible or springing members 128 overlaid with interior surface 15 of keycap stem 13. As shown with the overlap of flexible or springing members 128 with interior surface 15, flexible or springing members 128 are configured and disposed to deflect away from the keycap stem interior cavity walls or interior surface 15, producing a retentive force. The surfaces of the keycap stem interior wall 15 will balance the force from the flexible portions 128 of the key stem 114, precisely locating keycap 12 relative to the key stem 114 and holding keycap 12 securely in place.

FIG. 4B shows a notch 131 in flexible portion 128. Having a lower notch 131 in flexible portion 128 may configure key stem 114 to build up a full retentive force in interior surface 15 prior to keycap 12 being fully installed, which may mitigate a risk of unintended loosening of keycap 12 on key stem 114. Flexible portion 128 may have a tapered upper edge 133, which may aid with the installation of keycap 12 on key stem 114.

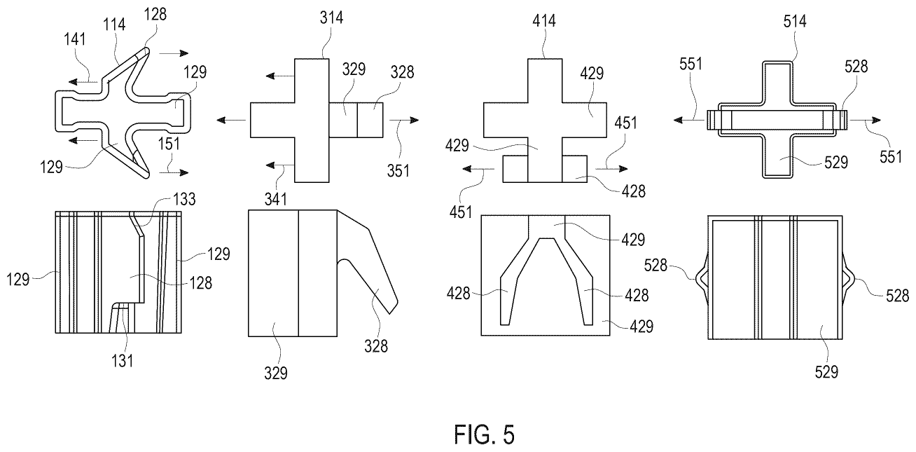

FIG. 5 shows illustrative examples of key stems 114, 314, 414, and 514 and associated forces for removably holding a keycap, such as keycap 12 or a longitudinally extending key like a spacebar. Key stems 114, 314, 414, and 514 each have four extensions disposed about a common center in a cruciform configuration.

Key stem 114 has two flexible or springing members 128 extending from oppositely disposed extensions 129, configured and disposed to exert forces 151 in one direction and causing reaction forces 141 in an opposite direction. The two flexible or springing members 128 are configured and disposed to exert forces 151 in the same direction. Each flexible or springing member 128 has a notch 131 in a lower end and a top edge 133 sloping away from the common center.

Key stem 314 has a sole flexible member 328 extending from an end of an extension 329. Flexible member 328 is configured and disposed to exert a force 351 in one direction causing at least one reaction force 341 from other extension(s) 329 in an opposite direction. Key stem 414 has a flexible member 428 extending from the lower end of an extension 429. Flexible member 428 is configured and disposed to exert forces 451 in opposite directions.

Key stem 514 has two flexible or spring members 528 extending from ends of oppositely disposed extending extensions 529. Flexible or spring members 528 are configured and disposed to exert forces 551 in opposite directions from the common center.

The presently disclosed key stem has one or more components with one or more springs or flexible elements that deform on assembly and produce a retentive force. Such flexible element(s) may be the key stem itself or combined with another flexible element that assembles onto the key stem (e.g. a metal spring). The flexible elements can be incorporated in one or more, even all, quadrants.

The presently disclosed key stem has at least one flexible or springing member extending from at least one extension, such as extending from a leg of a cruciform stem. The flexible or springing member may comprise a polymeric flexible material or one or more metal springs. The flexible or springing member is configured and disposed to exert at least one force against an interior side surface of a keycap stem sufficient to removably hold a keycap with the keycap stem.

One feature or aspect of an embodiment is believed at the time of the filing of this patent application to possibly reside broadly in a keyboard comprising: a plurality of keys supported with a keyboard switch plate or a PCB, each having a keycap; each of the keys are in communication with a keyboard switch configured and disposed to bias the keycaps from the keyboard switch plate or PCB; at least one of the keys has a key stem configured and disposed to interface with, and removably hold, one of the keycaps; the key stem extends upwardly from the keyboard switch or a keycap stabilizer and has two or more extensions extending outwardly from a common center; at least one flexible or springing member extends from or forms at least one of the extensions; the at least one flexible or springing member is configured and disposed to apply retentive forces on interior surfaces of a keycap stem extending downwardly from the keycap's interior ceiling and to removably hold the keycap with the key stem.

Another feature or aspect of an embodiment is believed at the time of the filing of this patent application to possibly reside broadly in the keyboard, wherein the key stem has four of the two or more extensions disposed about the common center in a cruciform configuration.

Yet another feature or aspect of an embodiment is believed at the time of the filing of this patent application to possibly reside broadly in the keyboard, wherein the at least one flexible or springing member comprises a sole flexible or springing member extending from an end of one of the four extensions.

Still another feature or aspect of an embodiment is believed at the time of the filing of this patent application to possibly reside broadly in the keyboard, wherein the at least one flexible or springing member comprises two flexible or springing members extending from oppositely disposed extensions.

A further feature or aspect of an embodiment is believed at the time of the filing of this patent application to possibly reside broadly in the keyboard, wherein the two flexible or springing members extending from oppositely disposed extensions are disposed to exert forces in opposite directions from the common center.

Another feature or aspect of an embodiment is believed at the time of the filing of this patent application to possibly reside broadly in the keyboard, wherein the two flexible or springing members extending from oppositely disposed extensions are disposed to exert forces in the same direction.

Yet another feature or aspect of an embodiment is believed at the time of the filing of this patent application to possibly reside broadly in the keyboard, wherein each of the two flexible or springing members have a notch in a lower portion.

Still another feature or aspect of an embodiment is believed at the time of the filing of this patent application to possibly reside broadly in the keyboard, wherein each of the two flexible or springing members have a tapered upper edge sloping away from the common center.

A further feature or aspect of an embodiment is believed at the time of the filing of this patent application to possibly reside broadly in a key stem configured and disposed to interface with, and removably hold, a keycap; the key stem extends upwardly from a keyboard switch or a keycap stabilizer and has two or more extensions extending outwardly from a common center; at least one flexible or springing member extends from at least one of the extensions; the at least one flexible or springing member is configured and disposed to apply retentive forces on interior surfaces of a keycap stem extending downwardly from the keycap's interior ceiling and to removably hold the keycap with the key stem.

Another feature or aspect of an embodiment is believed at the time of the filing of this patent application to possibly reside broadly in the key stem having four of the two or more extensions, the four extensions are disposed about the common center in a cruciform configuration.

Still another feature or aspect of an embodiment is believed at the time of the filing of this patent application to possibly reside broadly in the key stem, wherein the at least one flexible or springing member comprises a sole flexible or springing member extending from an end of one of the four extensions.

A further feature or aspect of an embodiment is believed at the time of the filing of this patent application to possibly reside broadly in the key stem, wherein the at least one flexible or springing member comprises two flexible or springing members extending from oppositely disposed extensions.

Another feature or aspect of an embodiment is believed at the time of the filing of this patent application to possibly reside broadly in the key stem, wherein the two flexible or springing members extending from oppositely disposed extensions are disposed to exert forces in opposite directions from the common center.

Yet another feature or aspect of an embodiment is believed at the time of the filing of this patent application to possibly reside broadly in the key stem, wherein the two flexible or springing members extending from oppositely disposed extensions are disposed to exert forces in the same direction.

Still another feature or aspect of an embodiment is believed at the time of the filing of this patent application to possibly reside broadly in the key stem, wherein each of the two flexible or springing members have a notch in a lower portion.

A further feature or aspect of an embodiment is believed at the time of the filing of this patent application to possibly reside broadly in the key stem, wherein each of the two flexible or springing members have a tapered upper edge sloping away from the common center.

### NOMENCLATURE

10 keyboard
11, 12 keycap
13 keycap stem
14 key stem
15 interior surfaces of keycap stem
16 keyboard switch/lifting mechanism
18 keyboard switch plate or PCB
28 key stem extension
30 force vectors
100 keycap holder
114 key stem
128, 328, 428, 528 flexible or springing member
129, 329, 429, 529 extension
131 notch
133 tapered upper edge
216 keyboard switch/lifting mechanism
200, 201 keycap holders
220 keycap stabilizer
221, 223 key stabilizer housing
314, 414, 514 key stem
141, 341 reaction force
151, 351, 451, 551 exert force

1. A keyboard comprising:
a plurality of keys, each supported with a keyboard switch plate or a PCB and having a keycap;
each of the keys are in communication with a keyboard switch configured and disposed to bias the keycaps from the keyboard switch plate or PCB;
at least one of the keys has a key stem configured and disposed to interface with, and removably hold, one of the keycaps;
the key stem extends upwardly from the keyboard switch or a keycap stabilizer and has two or more extensions extending outwardly from a common center;
at least one flexible or springing member extends from or forms at least one of the extensions;
the at least one flexible or springing member is configured and disposed to apply retentive forces on interior surfaces of a keycap stem extending downwardly from the keycap's interior ceiling and to removably hold the keycap with the key stem.

2. The keyboard of claim 1, wherein the key stem has four of the two or more extensions disposed about the common center in a cruciform configuration.

3. The keyboard of claim 2, wherein the at least one flexible or springing member comprises a sole flexible or springing member extending from an end of one of the four extensions.

4. The keyboard of claim 2, wherein the at least one flexible or springing member comprises two flexible or springing members extending from oppositely disposed extensions.

5. The keyboard of claim 4, wherein the two flexible or springing members extending from oppositely disposed extensions are disposed to exert forces in opposite directions from the common center.

6. The keyboard of claim 4, wherein the two flexible or springing members extending from oppositely disposed extensions are disposed to exert forces in the same direction.

7. The keyboard of claim 6, wherein each of the two flexible or springing members have a notch in a lower portion.

8. The keyboard of claim 6, wherein each of the two flexible or springing members have a tapered upper edge sloping away from the common center.

9. A key stem configured and disposed to interface with, and removably hold, a keycap;
the key stem extends upwardly from a keyboard switch or a keycap stabilizer and has two or more extensions extending outwardly from a common center;
at least one flexible or springing member extends from or forms at least one of the extensions;
the at least one flexible or springing member is configured and disposed to apply retentive forces on interior surfaces of a keycap stem extending downwardly from the keycap's interior ceiling and to removably hold the keycap with the key stem.

10. The key stem of claim 9 having four of the two or more extensions, the four extensions are disposed about the common center in a cruciform configuration.

11. The key stem of claim 10, wherein the at least one flexible or springing member comprises a sole flexible or springing member extending from an end of one of the four extensions.

12. The key stem of claim 10, wherein the at least one flexible or springing member comprises two flexible or springing members extending from oppositely disposed extensions.

13. The key stem of claim 10, wherein the two flexible or springing members extending from oppositely disposed extensions are disposed to exert forces in opposite directions from the common center.

14. The key stem of claim 10, wherein the two flexible or springing members extending from oppositely disposed extensions are disposed to exert forces in the same direction.

15. The key stem of claim 14, wherein each of the two flexible or springing members have a notch in a lower portion.

16. The key stem of claim 14, wherein each of the two flexible or springing members have a tapered upper edge sloping away from the common center.
